(19) United States
(12) Patent Application Publication
(10) Pub. No.: US 2026/0056483 A1
(43) Pub. Date: Feb. 26, 2026

(54) METHOD FOR PRODUCING TONER FOR DEVELOPING ELECTROSTATIC CHARGE IMAGES

(71) Applicant: FUJIFILM BUSINESS INNOVATION CORP., Tokyo (JP)

(72) Inventors: Keita YAMAMOTO, Kanagawa (JP); Yumi TANAKA, Kanagawa (JP); Takahisa TATEKAWA, Kanagawa (JP); Takahiro YAMASHITA, Kanagawa (JP)

(73) Assignee: FUJIFILM BUSINESS INNOVATION CORP., Tokyo (JP)

(21) Appl. No.: 19/192,984

(22) Filed: Apr. 29, 2025

(30) Foreign Application Priority Data
Aug. 26, 2024 (JP) 2024-144542

(51) Int. Cl. G03G 9/08; G03G 9/087

(52) U.S. Cl. CPC G03G 9/0804; G03G 9/08755

(57) ABSTRACT

A method for producing a toner for developing electrostatic charge images includes: forming first aggregated particles by aggregating amorphous resin particles (1), which are obtained by melt-mixing an amorphous resin and adding an aqueous medium to effect granulation, in a resin particle dispersion containing the amorphous resin particles (1); forming second aggregated particles by attaching amorphous resin particles (2), which are obtained by dissolving and mixing an amorphous resin with an organic solvent and adding an aqueous medium to effect granulation, to surfaces of the first aggregated particles in a resin particle dispersion containing the first aggregated particles and the amorphous resin particles (2); and fusing and coalescing the second aggregated particles into toner particles by heating a dispersion containing the second aggregated particles, in which the toner particles contain elemental sulfur, and an elemental sulfur content in the toner particles is 0.05 mass % or more and 0.20 mass % or less relative to a mass of the toner particles.

### CROSS-REFERENCE TO RELATED APPLICATIONS

This application is based on and claims priority under 35 USC 119 from Japanese Patent Application No. 2024-144542 filed Aug. 26, 2024.

### BACKGROUND

### (i) Technical Field

The present disclosure relates to a method for producing a toner for developing electrostatic charge images.

### (ii) Related Art

Japanese Unexamined Patent Application Publication No. 2011-081241 discloses a method for producing an electrophotographic toner including a step (1) of aggregating resin particles in a resin particle dispersion to form a dispersion of aggregated particles; a step (2) of adding a resin fine particle dispersion to the dispersion of the aggregated particles to form a dispersion of resin fine particle-attached aggregated particles; and a step (3) of coalescing the resin fine particle-attached aggregated particles in the dispersion of the resin fine particle-attached aggregated particles. The resin particle dispersion is prepared by a method having the step of dispersing a resin containing amorphous polyester and crystalline polyester in an aqueous medium in one reaction vessel. The resin fine particle dispersion is prepared by a method having the step of mixing a resin containing 80 wt % or more of amorphous polyester with an organic solvent and then adding an aqueous medium to disperse the resin.

Japanese Unexamined Patent Application Publication No. 2010-181802 discloses a toner having core particles containing at least a binder resin, a colorant, and a release agent, and a coating layer covering the core particles. The coating layer is formed by fixing resin fine particles to the surface of the core particles. The difference (Tg2−Tg1) between the glass transition temperature Tg1 of the core particles and the glass transition temperature Tg2 of the resin fine particles is 5° C. to 40° C. The resin fine particles are composed of a resin containing at least carboxyl groups and sulfonic acid groups. The elemental sulfur contained in the coating layer is 0.005 mass % to 0.050 mass % of the toner particles.

### SUMMARY

Aspects of non-limiting embodiments of the present disclosure relate to a production method for producing a toner for developing electrostatic charge images wherein the toner may prevent or reduce occurrence of image density unevenness.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a method for producing a toner for developing electrostatic charge images including:
forming first aggregated particles by aggregating amorphous resin particles (1), which are obtained by melt-mixing an amorphous resin and adding an aqueous medium to effect granulation, in a resin particle dispersion containing the amorphous resin particles (1);
forming second aggregated particles by attaching amorphous resin particles (2), which are obtained by dissolving and mixing an amorphous resin with an organic solvent and adding an aqueous medium to effect granulation, to surfaces of the first aggregated particles in a resin particle dispersion containing the first aggregated particles and the amorphous resin particles (2); and
fusing and coalescing the second aggregated particles into toner particles by heating a dispersion containing the second aggregated particles,
wherein the toner particles contain elemental sulfur, and an elemental sulfur content in the toner particles is 0.05 mass % or more and 0.20 mass % or less relative to a mass of the toner particles.

### BRIEF DESCRIPTION OF THE DRAWINGS

Exemplary embodiments of the present disclosure will be described in detail based on the following figures, wherein:

FIG. 1 is a schematic structural view of an example of an image forming apparatus according to an exemplary embodiment; and

FIG. 2 is a schematic structural view of an example of a process cartridge attachable to and detachable from the image forming apparatus according to this exemplary embodiment.

### DETAILED DESCRIPTION

Exemplary embodiments of the present disclosure will be described below. The following description and Examples are for illustrating the exemplary embodiments and are not intended to limit the scope of the exemplary embodiments.

A numerical range expressed by using “to” in exemplary embodiments of the present disclosure indicates a range including the values before and after “to” as the minimum value and the maximum value.

With regard to numerical ranges described stepwise in exemplary embodiments of the present disclosure, the upper or lower limit of one numerical range may be replaced by the upper or lower limit of another stepwise-described numerical range. The upper or lower limit of any numerical range described in exemplary embodiments of the present disclosure may be replaced by a value described in Examples.

The phase “A and/or B” in exemplary embodiments of the present disclosure has the same meaning as the phrase “at least one of A and B.” In other words, the phrase “A and/or B” means only A, only B, or a combination of A and B.

In exemplary embodiments of the present disclosure, the term “step” includes not only an independent step but also a step that cannot be clearly distinguished from other steps but may accomplish the purpose of the step.

In the description of exemplary embodiments with reference to the drawings in the present disclosure, the structures of the exemplary embodiments are not limited to the structures illustrated in the drawings. The sizes of members in each figure are schematic, and the relative relationship between the sizes of the members is not limited to what is illustrated.

In exemplary embodiments of the present disclosure, each component may include two or more corresponding substances. In exemplary embodiments of the present disclosure, the amount of each component in a composition refers to, when there are two or more substances corresponding to each component in the composition, the total amount of the substances present in the composition, unless otherwise specified.

In exemplary embodiments of the present disclosure, each component may include two or more types of particles corresponding to each component. The particle size of each component refers to, when there are two or more types of particles corresponding to each component in the composition, the particle size of a mixture of two or more types of particles present in the composition, unless otherwise specified.

In the present disclosure, the expression “(meth)acrylic” includes both acrylic and methacrylic, and the expression “(meth)acrylate” includes both acrylate and methacrylate.

In the present disclosure, the “developer” refers to an “electrostatic charge image developer,” the “carrier” refers to a “carrier for developing electrostatic charge images,” and the “toner” refers to a “toner for developing electrostatic charge images.”

In the present disclosure, a method for producing toner particles by aggregating and coalescing material particles in a dispersion medium is called the emulsion aggregation (EA) method.

### Method for Producing Toner for Developing Electrostatic Charge Images

A toner production method according to an exemplary embodiment of the disclosure includes producing toner particles by the EA method and includes a first aggregation step, a second aggregation step, and a coalescence step as described below.

First Aggregation Step: A step of forming first aggregated particles by aggregating amorphous resin particles (1), which are obtained by melt-mixing an amorphous resin and adding an aqueous medium to effect granulation, in a resin particle dispersion containing the amorphous resin particles (1).

Second Aggregation Step: A step of forming second aggregated particles by attaching amorphous resin particles (2), which are obtained by dissolving and mixing an amorphous resin with an organic solvent and adding an aqueous medium to effect granulation, to the surfaces of the first aggregated particles in a resin particle dispersion containing the first aggregated particles and the amorphous resin particles (2).

Coalescence Step: A step of fusing and coalescing the second aggregated particles into toner particles by heating the dispersion containing the second aggregated particles.

The first aggregation step is a step for forming the core of the toner particles with a core-shell structure. The second aggregation step is a step for forming the shell of the toner particles with a core-shell structure. The toner particles with a core-shell structure can be produced through the first aggregation step, the second aggregation step, and the coalescence step.

The granulation for forming the amorphous resin particles (1) is performed in the absence of organic solvents, that is, substantially free of organic solvents, or performed in the presence of organic solvents in the amount of 10 mass % or less relative to the resin. The granulation for forming the amorphous resin particles (1) may be performed in the absence of organic solvents.

The granulation for forming the amorphous resin particles (2) uses organic solvents.

The toner production method according to the exemplary embodiment includes the first aggregation step and the second aggregation step, and the elemental sulfur content in the toner particles is 0.05 mass % or more and 0.20 mass % or less relative to the mass of the toner particles. The image formation using a toner containing elemental sulfur causes a phenomenon in which image density unevenness occurs due to charge injection in a high temperature-high humidity environment, but the toner production method according to the exemplary embodiment produces a toner that may prevent or reduce occurrence of image density unevenness. The mechanism for this is assumed as described below.

Resin particle dispersions used in the EA method and other chemical toner production methods are generally resin particle dispersions containing resin particles obtained by dissolving and mixing a resin with an organic solvent and adding an aqueous medium to effect granulation (i.e., resin particle dispersions produced by the inverted phase emulsification method using an organic solvent), or resin particle dispersions containing resin particles obtained by melt-mixing a resin and adding an aqueous medium to effect granulation (i.e., resin particle dispersions produced by using the forced emulsification method or other methods under high pressure-high temperature conditions).

In the granulation for forming the amorphous resin particles (2), the dissolved mixture of the amorphous resin and the organic solvent tends to be hydrophobic due to the hydrophobic nature of the organic solvent, and hydrophilic groups tend to exist on the surface of the amorphous resin particles (2) in the resin particle dispersion obtained by granulation with the addition of the aqueous medium.

In the granulation for forming the amorphous resin particles (1) in the exemplary embodiment, the molten mixture of the amorphous resin is relatively less hydrophobic due to the absence of organic solvents, and hydrophilic groups tend to exist inside the amorphous resin particles (1) in the resin particle dispersion obtained by granulation with the addition of the aqueous medium.

Therefore, the toner particles with a core-shell structure produced by using the amorphous resin particles (1) to form the core and the amorphous resin particles (2) to form the shell tend to have hydrophilic groups on the surfaces of the toner particles and inside the toner particles. When these toner particles are exposed to a high temperature-high humidity environment, moisture on the surfaces of the toner particles may migrate into the toner via the hydrophilic groups of the amorphous resin particles (2), elemental sulfur in the toner particles, and the hydrophilic groups of the amorphous resin particles (1) inside the toner particles and may remain within the toner. As a result, charge injection into the toner may be prevented or reduced, and image density unevenness may be prevented or reduced.

If the elemental sulfur content in the toner particles is less than 0.05 mass % relative to the mass of the toner particles, moisture is less likely to move into the toner particles, so that the amount of moisture adsorbed on the toner particle surface relatively increases, and image density unevenness tends to occur due to charge injection. To prevent or reduce this phenomenon, the elemental sulfur content in the toner particles is 0.05 mass % or more, preferably 0.08 mass % or more, more preferably 0.10 mass % or more.

If the elemental sulfur content in the toner particles is more than 0.20 mass % relative to the mass of the toner particles, excessive moisture remains inside the toner particles, making it difficult to prevent or reduce charge injection into the toner. To prevent or reduce this phenomenon, the elemental sulfur content in the toner particles is 0.20 mass % or less, preferably 0.18 mass % or less, more preferably 0.15 mass % or less.

The elemental sulfur content in the toner particles can be controlled by using an appropriate amount of an elemental sulfur-containing material in the granulation for forming the material particles for the toner particles and/or in the granulation for forming the toner particles. Examples of the elemental sulfur-containing material include surfactants, binder resins or other components that themselves contain elemental sulfur as a resin chain transfer agent, with surfactants containing elemental sulfur being preferred. Examples of surfactants containing a sulfur atom include sulfonate surfactants.

The elemental sulfur content in the toner particles is determined by the following measurement method.

If the toner contains external additives, the external additives are removed from the toner particles by ultrasonication. Specifically, 1 mass % of the toner is added to a 10 mass % aqueous ethanol solution, and ultrasonic vibration with an output of 20 W and a frequency of 20 kHz is applied for 30 minutes to remove the external additives from the toner particles, followed by centrifugal separation and drying to obtain the toner particles.

The toner particles (0.130 g) are precisely weighed and formed into a disc shape. Using the formed material as a sample, qualitative quantitative total elemental analysis is performed by X-ray fluorescence analysis to determine the elemental sulfur content (mass %). The X-ray fluorescence analysis is carried out using the following device and conditions.
Scanning X-ray fluorescence analyzer: ZSX Primus II, Rigaku Holdings Corporation
X-ray output: 40 mA to 70 mA
Measurement area: 10 mm in diameter
Measurement time: 15 minutes

If the peak of elemental sulfur overlaps the peaks of other elements, the sample is further analyzed by ICP emission spectroscopy and/or atomic absorption spectroscopy to determine the elemental sulfur content (mass %).

In the toner production method according to the exemplary embodiment of the present disclosure, the amorphous resin particles (1) may contain elemental sulfur, and the elemental sulfur content in the amorphous resin particles (1) may be 0.10 mass % or more and 0.25 mass % or less relative to the mass of the amorphous resin of the amorphous resin particles (1).

When the elemental sulfur content in the amorphous resin particles (1) is 0.10 mass % or more, moisture may tend to remain inside the toner particles in melt-mixing the amorphous resin and adding an aqueous medium to effect granulation, possibly because elemental sulfur is kneaded into the amorphous resin particles (1) together with hydrophilic groups, which may make it easier to prevent or reduce charge injection into the toner. From this viewpoint, the elemental sulfur content in the amorphous resin particles (1) is more preferably 0.11 mass % or more, still more preferably 0.12 mass % or more.

When the elemental sulfur content in the amorphous resin particles (1) is 0.25 mass % or less, an appropriate amount of elemental sulfur is kneaded into the amorphous resin particles (1) together with hydrophilic groups, and moisture may tend to remain inside the toner particles, which may make it easier to prevent or reduce charge injection into the toner. From this viewpoint, the elemental sulfur content in the amorphous resin particles (1) is more preferably 0.20 mass % or less, still more preferably 0.16 mass % or less.

The elemental sulfur content in the amorphous resin particles (1) can be controlled by using an appropriate amount of an elemental sulfur-containing material in the granulation for forming the amorphous resin particles (1). Examples of the elemental sulfur-containing material include surfactants. Examples of the surfactants include sulfonate surfactants.

In the toner production method according to the exemplary embodiment of the present disclosure, the elemental sulfur content in the amorphous resin particles (2) is preferably 0.10 mass % or less, preferably as low as possible, ideally 0 mass %, relative to the mass of the amorphous resin of the amorphous resin particles (2), to make moisture more likely to remain inside the toner.

The elemental sulfur content in the amorphous resin particles (2) can be controlled to be 0.10 mass % or less by either not using any elemental sulfur-containing material or if used, removing the elemental sulfur-containing material by washing or other methods in the granulation for forming the amorphous resin particles (2). Examples of the elemental sulfur-containing material include sulfonate surfactants.

The elemental sulfur content in the amorphous resin particles (1) and the elemental sulfur content in the amorphous resin particles (2) are each determined by the following measurement methods.

The resin particle dispersion (5 mL) is subjected to solid-liquid separation. The separated resin particles are washed by flowing 200 mL of deionized water through the resin particles and dried in a freeze dryer for 24 hours to obtain a resin particle powder.

The resin particle powder (0.130 g) is precisely weighed and formed into a disc shape. Using the formed material as a sample, qualitative quantitative total elemental analysis is performed by X-ray fluorescence analysis to determine the elemental sulfur content (mass %). The X-ray fluorescence analysis is carried out using the following device and conditions.
Scanning X-ray fluorescence analyzer: ZSX Primus II, Rigaku Holdings Corporation
X-ray output: 40 mA to 70 mA
Measurement area: 10 mm in diameter
Measurement time: 15 minutes

If the peak of elemental sulfur overlaps the peaks of other elements, the sample is further analyzed by ICP emission spectroscopy and/or atomic absorption spectroscopy to determine the elemental sulfur content (mass %).

In the toner production method according to the exemplary embodiment of the present disclosure, the value obtained by dividing the elemental sulfur content in the toner particles (the mass percentage of elemental sulfur relative to the mass of the toner particles) by the elemental sulfur content in the amorphous resin particles (1) (the mass percentage of elemental sulfur relative to the mass of the amorphous resin of the amorphous resin particles (1)) is preferably 1 or less, more preferably 0.9 or less, still more preferably 0.8 or less, to produce a toner that may prevent or reduce occurrence of image density unevenness.

To make moisture more likely to remain inside the toner, the result of division is preferably 0.4 or more, more preferably 0.6 or more, still more preferably 0.7 or more.

In the toner production method according to the exemplary embodiment of the present disclosure, the toner particles contain elemental nitrogen, and the value (ppm/mass %) obtained by dividing the elemental nitrogen content (ppm) in the surfaces of the toner particles by the elemental sulfur content in the toner particles (the mass percentage of elemental sulfur relative to the mass of the toner particles, mass %) is preferably 50 or less, more preferably 40 or less, still more preferably 30 or less, to produce a toner that may prevent or reduce occurrence of image density unevenness.

The result of division is preferably 3 or more, more preferably 6 or more, still more preferably 10 or more to make the toner more likely to retain moisture therein.

In the toner production method according to the exemplary embodiment of the present disclosure, the elemental nitrogen content in the surfaces of the toner particles is preferably 0.3 ppm or more and 10 ppm or less, more preferably 0.5 ppm or more and 8 ppm or less, still more preferably 0.7 ppm or more and 5 ppm or less.

The elemental nitrogen content in the surfaces of the toner particles can be controlled by using an appropriate amount of an elemental nitrogen-containing material in the granulation for forming the material particles for the toner particles and/or in the granulation for forming the toner particles. Examples of the elemental nitrogen-containing material include surfactants, binder resins, resin chain transfer agents, and pH adjusters, with pH adjusters containing elemental nitrogen being preferred. Examples include counterions for anionic surfactants, nitric acid, ammonium nitrate, and ammonium sulfate.

The elemental nitrogen content in the surfaces of the toner particles is determined by the following measurement method.

If the toner contains external additives, the external additives are removed from the toner particles by ultrasonication. Specifically, 1 mass % of the toner is added to a 10 mass % aqueous ethanol solution, and ultrasonic vibration with an output of 20 W and a frequency of 20 kHz is applied for 30 minutes to remove the external additives from the toner particles, followed by centrifugal separation and drying to obtain the toner particles.

The toner particles (0.5 g) are precisely weighed, and 1 g of a 10 mass % nonionic surfactant and 98.5 g of ultrapure water are added, followed by application of ultrasonic waves for 30 minutes in a thermostatic bath controlled at 30° C.±1° C. to disperse the toner particles. The toner particles are separated from the dispersion by filtration, and the cationic and anionic components of the filtrate are quantitatively analyzed by ion chromatography (ICS-2000, Nippon Dionex K.K). The elemental nitrogen content (ppm) is quantitatively analyzed by integrating the amount of elemental nitrogen in elemental nitrogen-containing ions (e.g., ammonium ion, nitrate ion) among the cationic and anionic components.

The amorphous resin particles (1) and the amorphous resin particles (2) will be described below in detail.

### Amorphous Resin Particles (1)

The amorphous resin particles (1) are obtained by melt-mixing an amorphous resin and adding an aqueous medium to effect granulation.

The granulation method for the amorphous resin particles (1) includes, for example, mixing an amorphous resin with an optional basic compound and an optional surfactant while applying heat and shear force, and then adding an aqueous medium while applying shear force.

Any device can be used for the granulation for forming the amorphous resin particles (1) and can be appropriately selected according to the purpose. Examples of the device include batch kneaders and kneading extruders, with kneading extruders being preferred. A kneading extruder is a device that applies heat and shearing force to a feed material while continuously conveying the feed material. The structure of the kneading extruder is generally divided into three parts in order from upstream to downstream: a material feed port, a barrel, and a die. The kneading extruder includes a screw inside the barrel. A heater that heats the inside of the barrel is provided around the barrel. The screw may be either a single-screw type or a twin-screw type, with a single-screw type being preferred.

The basic compound may be sodium hydroxide or potassium hydroxide. Sodium hydroxide or potassium hydroxide may be used in the form of an aqueous solution (i.e., sodium hydroxide aqueous solution or potassium hydroxide aqueous solution) from the viewpoint of uniformity in kneading.

The amount of the basic compound used is sufficient to achieve dispersion of the mixture in an aqueous medium. Specifically, the amount of the basic compound used may be an amount that achieves a neutralization ratio of 30% or more and 60% or less according to formula (1) below.

$$Neutralization ratio ( \% ) = mb \times n \times 56.1 / Mwb / AV \times 1000 \qquad Formula ( 1 )$$

$$mb is the amount ( g ) of the basic compound used per gram of the resin ,$$

$$n is the valence of the basic compound ,$$

$$Mwb is the molecular weight of the basic compound , and$$

$$AV is the acid value ( mg KOH / g ) of the resin .$$

The surfactant may be an anionic surfactant, a cationic surfactant, or a nonionic surfactant. Examples of the surfactant include anionic surfactants, such as sulfate salts, sulfonate salts, phosphate salts, and soaps; cationic surfactants, such as amine salts and quaternary ammonium salts; and nonionic surfactants, such as polyethylene glycols, alkylphenol ethylene oxide adducts, and polyhydric alcohols. The surfactants may be used singly or in combination of two or more. A nonionic surfactant may be used in combination with an anionic surfactant or a cationic surfactant.

The amount of the surfactant used is sufficient to maintain dispersion of the particles dispersed in an aqueous medium.

An appropriate amount of sulfonate surfactant may be used as a surfactant in order to control the elemental sulfur content in the amorphous resin particles (1) to the desired value.

The aqueous medium may be water with low ion content, such as distilled water or ion-exchanged water. The aqueous medium may be adjusted to a temperature in the range of 35° C. or higher and 100° C. or lower for use. The temperature of the aqueous medium may be adjusted in the range of the barrel inner temperature of the kneading extruder ±5° C. for use.

The barrel inner temperature of the kneading extruder is preferably 80° C. or higher and 110° C. or lower, more preferably 85° C. or higher and 105° C. or lower, still more preferably 90° C. or higher and 100° C. or lower.

The amorphous resin constituting the amorphous resin particles (1) may be an amorphous polyester resin. The amorphous polyester resin may be a commercial product or a synthetic product. Examples of the amorphous polyester resin include polycondensates of polycarboxylic acids and polyhydric alcohols.

Examples of the polycarboxylic acid, which is a polymer component of the amorphous polyester resin, include aliphatic dicarboxylic acids (e.g., oxalic acid, malonic acid, maleic acid, fumaric acid, citraconic acid, itaconic acid, glutaconic acid, succinic acid, alkenyl succinic acid, adipic acid, and sebacic acid), alicyclic dicarboxylic acids (e.g., cyclohexanedicarboxylic acid), aromatic dicarboxylic acids (e.g., terephthalic acid, isophthalic acid, orthophthalic acid, naphthalene dicarboxylic acid), anhydrides thereof, and lower (e.g., C1 to C5) alkyl esters thereof. Of these, the polycarboxylic acid may be an aromatic dicarboxylic acid.

The polycarboxylic acid may be a combination of a dicarboxylic acid and a trivalent or higher valent carboxylic acid having a cross-linked structure or branched structure. Examples of the trivalent or higher valent carboxylic acid include trimellitic acid, pyromellitic acid, anhydrides thereof, and lower (e.g., C1 to C5) alkyl esters thereof.

The polycarboxylic acids may be used singly or in combination of two or more.

Examples of the polyhydric alcohol, which is a polymer component of the amorphous polyester resin, include aliphatic diols (e.g., ethylene glycol, diethylene glycol, triethylene glycol, propylene glycol, neopentyl glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, and 1,14-eicosanedecanediol), alicyclic diols (e.g., cyclohexanediol, cyclohexanedimethanol, and hydrogenated bisphenol A), and aromatic diols (e.g., an ethylene oxide adduct of bisphenol A, and a propylene oxide adduct of bisphenol A). Of these, the polyhydric alcohol may be an aliphatic diol.

The polyhydric alcohol, which is a polymer component of the amorphous polyester resin, may be a combination of a diol and a trihydric or higher polyhydric alcohol having a cross-linked structure or branched structure. Examples of the trihydric or higher polyhydric alcohol include glycerol, trimethylolpropane, and pentaerythritol.

The polyhydric alcohols may be used singly or in combination of two or more.

The glass transition temperature (Tg) of the amorphous polyester resin is preferably 50° C. or higher and 70° C. or lower, more preferably 52° C. or higher and 65° C. or lower, still more preferably 54° C. or higher and 60° C. or lower.

The glass transition temperature is determined from the differential scanning calorimetry (DSC) curve obtained by DSC and, more specifically, determined in accordance with “extrapolated glass transition onset temperature” described in the method for determining the glass transition temperature in JIS K 7121-1987 “Testing Methods for Transition Temperatures of Plastics”.

The weight-average molecular weight (Mw) of the amorphous polyester resin is preferably 5,000 or more and 1,000,000 or less, more preferably 7,000 or more and 500,000 or less.

The number-average molecular weight (Mn) of the amorphous polyester resin is preferably 1,500 or more and 100,000 or less, more preferably 2,000 or more and 95,000 or less.

The molecular weight distribution Mw/Mn of the amorphous polyester resin is preferably 1.5 or more and 100 or less, more preferably 2 or more and 60 or less.

The weight-average molecular weight and the number-average molecular weight are determined by gel permeation chromatography (GPC). The determination of the molecular weight by GPC is carried out by using a measurement system HLC-8120GPC (Tosoh Corporation), a column TSKgel SuperHM-M (15 cm in diameter, Tosoh Corporation), and a solvent tetrahydrofuran (THF). The weight-average molecular weight and the number-average molecular weight are calculated from the molecular weight calibration curve created from the measurement results by using a monodisperse polystyrene standard.

### Amorphous Resin Particles (2)

The amorphous resin particles (2) are obtained by dissolving and mixing an amorphous resin with an organic solvent and adding an aqueous medium to effect granulation.

The granulation method for the amorphous resin particles (2) includes, for example, mixing an amorphous resin and an organic solvent in which the amorphous resin is soluble while applying heat to dissolve the amorphous resin in the organic solvent, next mixing a basic compound, and then adding an aqueous medium while applying shear force to effect granulation.

The granulation for forming the amorphous resin particles (2) may be performed in a stirring tank equipped with a stirring unit and a heating/cooling unit. The stirring unit may be a stirring unit having a rotation shaft and a stirring blade. The heating/cooling unit may be a unit for applying and/or removing heat to/from the wall surface of the stirring tank.

When the amorphous resin is an amorphous polyester resin, examples of the organic solvent in which the amorphous polyester resin is soluble include ethyl acetate, isopropanol, 2-butanol, methyl ethyl ketone, and mixed solvents thereof. Among these, organic solvents or mixed solvents with boiling points of 60° C. or higher and lower than 100° C. are preferred. The basic compound may be ammonia water.

The amount of the basic compound used is sufficient to achieve dispersion of the mixture in an aqueous medium. Specifically, the amount of the basic compound used may be an amount that achieves a neutralization ratio of 50% or more and 100% or less according to formula (1) below.

$$Neutralization ratio ( \% ) = mb \times n \times 56.1 / Mwb / AV \times 1000 \qquad Formula ( 1 )$$

$$mb is the amount ( g ) of the basic compound used per gram of the resin ,$$

$$n is the valence of the basic compound ,$$

$$Mwb is the molecular weight of the basic compound , and$$

$$AV is the acid value ( mg KOH / g ) of the resin .$$

The aqueous medium may be water with low ion content, such as distilled water or ion-exchanged water. The aqueous medium may be adjusted to a temperature in the range of 35° C. or higher and 100° C. or lower (e.g., a temperature range of 35° C. or higher and 55° C. or lower) for use.

The temperature of the feed material placed in the stirring tank is preferably 25° C. or higher and 60° C. or lower, more preferably 30° C. or higher and 55° C. or lower, still more preferably 35° C. or higher and 50° C. or lower.

The aqueous medium may be added dropwise. The dropwise addition time of the specified amount of the aqueous medium (twice the amount of the resin) is preferably 10 minutes or more and 150 minutes or less, more preferably 20 minutes or more and 140 minutes or less, still more preferably 30 minutes or more and 130 minutes or less.

After the addition of the aqueous medium is completed, the organic solvent may be removed by reducing the pressure in the stirring tank and/or bubbling the dispersion. Subsequently, a surfactant may be added to improve the dispersion stability of the particles. When the surfactant is added, the amount of the surfactant added is sufficient to maintain dispersion of the particles dispersed in the aqueous medium.

To reduce the elemental sulfur content in the amorphous resin particles (2), it may be possible to avoid the use of sulfonate surfactant.

The amorphous resin constituting the amorphous resin particles (2) may be an amorphous polyester resin. The specific form and preferred form of the amorphous polyester resin constituting the amorphous resin particles (2) are the same as the specific form and preferred form of the amorphous polyester resin constituting the amorphous resin particles (1) described above.

The details of the steps and the materials in the EA method will be described below.

### First Aggregation Step

The first aggregation step is a step for forming the core of the toner with a core-shell structure. The first aggregation step involves aggregating at least the amorphous resin particles (1) in a dispersion containing at least the amorphous resin particles (1) to form first aggregated particles.

The dispersion to be subjected to the first aggregation step contains at least the amorphous resin particles (1). The dispersion to be subjected to the first aggregation step may further contain crystalline resin particles. The dispersion to be subjected to the first aggregation step may further contain release agent particles. The dispersion to be subjected to the first aggregation step may further contain colorant particles.

The dispersion to be subjected to the first aggregation step is prepared by, for example, preparing an amorphous resin particle (1) dispersion, a crystalline resin particle dispersion, a release agent particle dispersion, and a colorant particle dispersion, and mixing these particle dispersions. These particle dispersions may be mixed in any order.

The crystalline resin particles contained in the crystalline resin particle dispersion may be obtained by dissolving and mixing an amorphous resin with an organic solvent and adding an aqueous medium to effect granulation. In other words, the crystalline resin particle dispersion may be produced by dissolving and mixing an organic solvent and adding an aqueous medium.

The specific form and preferred form in the granulation for forming the crystalline resin particles are the same as the specific form and preferred form in the granulation for forming the amorphous resin particles (2) described above.

When the crystalline resin is a crystalline polyester resin, examples of the organic solvent in which the crystalline polyester resin is soluble include ethyl acetate, isopropanol, 2-butanol, methyl ethyl ketone, and mixed solvents thereof. Among these, organic solvents or mixed solvents with boiling points of 60° C. or higher and lower than 100° C. are preferred.

### Crystalline Polyester Resin

The crystalline polyester resin may be a commercial product or a synthetic product.

Examples of the crystalline polyester resin include a polycondensate of a polycarboxylic acid and a polyhydric alcohol. The crystalline polyester resin may be a polycondensate produced by using a straight-chain aliphatic polymerizable monomer rather than a polymerizable monomer having an aromatic ring in order to easily form a crystal structure.

Examples of the polycarboxylic acid, which is a polymer component of the crystalline polyester resin, include aliphatic dicarboxylic acids (e.g., oxalic acid, succinic acid, glutaric acid, adipic acid, suberic acid, azelaic acid, sebacic acid, 1,9-nonanedicarboxylic acid, 1,10-decanedicarboxylic acid, 1,12-dodecanedicarboxylic acid, 1,14-tetradecanedicarboxylic acid, and 1,18-octadecanedicarboxylic acid), aromatic dicarboxylic acids (e.g., dibasic acids, such as phthalic acid, isophthalic acid, terephthalic acid, and naphthalene-2,6-dicarboxylic acid), anhydrides thereof, and lower (e.g., C1 to C5) alkyl esters thereof.

The polycarboxylic acid may be a combination of a dicarboxylic acid and a trivalent or higher valent carboxylic acid having a cross-linked structure or branched structure. Examples of the trivalent carboxylic acid include aromatic carboxylic acids (e.g., 1,2,3-benzenetricarboxylic acid, 1,2,4-benzenetricarboxylic acid, and 1,2,4-naphthalenetricarboxylic acid), anhydrides thereof, and lower (e.g., C1 to C5) alkyl esters thereof.

The polycarboxylic acid may be a combination of these dicarboxylic acids and a dicarboxylic acid having a sulfonic acid group or a dicarboxylic acid having an ethylenic double bond.

The polycarboxylic acids may be used singly or in combination of two or more.

Examples of the polyhydric alcohol, which is a polymer component of the crystalline polyester resin, include aliphatic diols (e.g., straight-chain aliphatic diols having 7 to 20 carbon atoms in the main chain). Examples of aliphatic diols include ethylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, and 1,14-eicosanedecanediol.

The polyhydric alcohol, which is a polymer component of the crystalline polyester resin, may be a combination of a diol and a trihydric or higher polyhydric alcohol having a cross-linked structure or branched structure. Examples of the trihydric or higher polyhydric alcohol include glycerol, trimethylolethane, trimethylolpropane, and pentaerythritol.

The polyhydric alcohols may be used singly or in combination of two or more.

The melting temperature of the crystalline polyester resin is preferably 50° C. or higher and 100° C. or lower, more preferably 55° C. or higher and 90° C. or lower, still more preferably 60° C. or higher and 85° C. or lower.

The melting temperature is determined from the differential scanning calorimetry (DSC) curve obtained by DSC in accordance with “melting peak temperature” described in the method for determining the melting temperature in JIS K 7121-1987 “Testing Methods for Transition Temperatures of Plastics”.

The weight-average molecular weight (Mw) of the crystalline polyester resin may be 6,000 or more and 35,000 or less.

Next, the release agent particle dispersion and the release agent, and the colorant particle dispersion, and the colorant particles will be described. The common features of the release agent particle dispersion and the colorant particle dispersion will be described below by collectively referring these particle dispersions to as a “particle dispersion.”

An exemplary embodiment of the particle dispersion is a dispersion prepared by dispersing a material in the form of particles in a dispersion medium by using a surfactant.

The dispersion medium for the particle dispersion may be an aqueous medium. Examples of the aqueous medium include water and alcohols. Water may be water with low ion content, such as distilled water or ion-exchanged water. These aqueous media may be used alone or in combination of two or more.

The surfactant used to disperse the material in the dispersion medium may be an anionic surfactant, a cationic surfactant, or a nonionic surfactant. Examples of the surfactant include anionic surfactants, such as sulfate salts, sulfonate salts, phosphate salts, and soaps; cationic surfactants, such as amine salts and quaternary ammonium salts; and nonionic surfactants, such as polyethylene glycols, alkylphenol ethylene oxide adducts, and polyhydric alcohols. The surfactants may be used singly or in combination of two or more. A nonionic surfactant may be used in combination with an anionic surfactant or a cationic surfactant.

Examples of the method for dispersing the material in the form of particles in the dispersion medium include known dispersion methods using a rotary shear homogenizer, a ball mill having media, and a sand mill, and Dyno-Mill.

The volume-average particle size of the particles dispersed in the particle dispersion is preferably 30 nm or more and 300 nm or less, more preferably 50 nm or more and 250 nm or less, still more preferably 80 nm or more and 200 nm or less.

The volume-average particle size of the particles in the particle dispersion refers to the particle size at which the cumulative volume reaches 50% from the smallest particle size in the particle size distribution measured with a laser diffraction-type particle size distribution analyzer. The number of particles to be measured is 10,000.

The amount of the particles contained in the particle dispersion is preferably 5 mass % or more and 50 mass % or less, more preferably 10 mass % or more and 40 mass % or less, still more preferably 15 mass % or more and 30 mass % or less.

### Release Agent

Examples of the release agent include hydrocarbon waxes; natural waxes, such as carnauba wax, rice wax, and candelilla wax; synthetic or mineral and petroleum waxes, such as montan wax; and ester waxes, such as waxes of fatty acid esters and montanic acid esters. The release agent is not limited to these.

The melting temperature of the release agent is preferably 50° C. or higher and 110° C. or lower, more preferably 60° C. or higher and 100° C. or lower.

The melting temperature of the release agent is determined from the differential scanning calorimetry (DSC) curve obtained by DSC in accordance with “melting peak temperature” described in the method for determining the melting temperature in JIS K 7121:1987 “Testing Methods for Transition Temperatures of Plastics”.

### Colorant

Examples of the colorant include pigments, such as carbon black, chrome yellow, hansa yellow, benzidine yellow, threne yellow, quinoline yellow, pigment yellow, permanent orange GTR, pyrazolone orange, vulcan orange, watchung red, permanent red, brilliant carmine 3B, brilliant carmine 6B, DuPont oil red, pyrazolone red, lithol red, rhodamine B lake, lake red C, pigment red, rose bengal, aniline blue, ultramarine blue, calco oil blue, methylene blue chloride, phthalocyanine blue, pigment blue, phthalocyanine green, malachite green oxalate; and dyes, such as acridine dyes, xanthene dyes, azo dyes, benzoquinone dyes, azine dyes, anthraquinone dyes, thioindigo dyes, dioxazine dyes, thiazine dyes, azomethine dyes, indigo dyes, phthalocyanine dyes, aniline black dyes, polymethine dyes, triphenylmethane dyes, diphenylmethane dyes, and thiazole dyes; and inorganic pigments, such as titanium compounds and silica.

These colorants may be used alone or in combination of two or more.

The colorant is not limited to a substance having absorption in the visible light region. The colorant may be, for example, a substance having absorption in the near-infrared region, or a fluorescent colorant.

Examples of the colorant having absorption in the near-infrared region include aminium salt compounds, naphthalocyanine compounds, squarylium compounds, and croconium compounds.

Examples of the fluorescent colorant include fluorescent colorants described in paragraph 0027 of Japanese Unexamined Patent Application Publication No. 2021-127431.

The colorant may be a glitter colorant. Examples of the glitter colorant include metal powders, such as powders made of aluminum, brass, bronze, nickel, stainless steel, and zinc; mica coated with titanium dioxide or yellow iron oxide; barium sulfate, layered silicates, and flaky inorganic crystal substrates composed of layered aluminum coated with silicates or other substances; single-crystal plate-like titanium dioxide, basic carbonates, bismuth oxychloride, natural guanine, flaky glass powder, and metal-deposited flaky glass powder.

These colorants may be used alone or in combination of two or more.

The colorant may be surface-treated as desired, or may be used in combination with a dispersant.

The toner particles may contain the colorant or may not contain the colorant. The toner may be a so-called transparent toner, a toner in which the toner particles contain no colorant.

Hereinafter, a dispersion formed by mixing two or more material dispersions is referred to as a “mixed dispersion”.

The mass ratio of the particles contained in the mixed dispersion may be in the following range.

When the mixed dispersion contains the release agent particles, the mass ratio of the binder resin particles to the release agent particles (binder resin particles: release agent particles) is preferably from 100:1 to 100:40, more preferably from 100:2 to 100:30, still more preferably from 100:5 to 100:20.

When the mixed dispersion contains the colorant particles, the mass ratio of the binder resin particles to the colorant particles (binder resin particles: colorant particles) is preferably from 100:1 to 100:100, more preferably from 100:2 to 100:40, still more preferably from 100:5 to 100:20.

After mixing two or more material dispersions, the pH of the mixed dispersion may be adjusted in the range of 3 or more and 4 or less. Examples of the method for adjusting the pH of the mixed dispersion include addition of an aqueous solution of nitric acid, an aqueous solution of hydrochloric acid, or an aqueous solution of sulfuric acid, which is an acidic aqueous solution.

The aggregation step includes, for example,
adding an aggregating agent to the mixed dispersion while stirring the mixed dispersion; and
after adding the aggregating agent to the mixed dispersion, increasing the temperature of the mixed dispersion by heating the mixed dispersion while stirring the mixed dispersion.

Examples of the aggregating agent include surfactants having polarity opposite to the polarity of the surfactant contained in the mixed dispersion, inorganic metal salts, and divalent or higher valent metal complexes. The aggregating agent may be used alone or in combination of two or more.

Examples of inorganic metal salts include metal salts, such as calcium chloride, calcium nitrate, barium chloride, magnesium chloride, zinc chloride, aluminum chloride, and aluminum sulfate; and inorganic metal salt polymers, such as polyaluminum chloride, polyaluminum hydroxide, and calcium polysulfide.

The aggregating agent is preferably a divalent or higher valent metal salt compound, more preferably a trivalent metal salt compound, still more preferably a trivalent inorganic aluminum salt compound. Examples of trivalent inorganic aluminum salt compounds include aluminum chloride, aluminum sulfate, polyaluminum chloride, and polyaluminum hydroxide.

The amount of the aggregating agent added is not limited. When a trivalent metal salt compound is used as an aggregating agent, the amount of the trivalent metal salt compound added relative to 100 parts by mass of the binder resin is preferably 0.01 parts by mass or more and 10 parts by mass or less, more preferably 0.05 parts by mass or more and 5 parts by mass or less, still more preferably 0.1 parts by mass or more and 3 parts by mass or less.

The temperature reached by the mixed dispersion during heating of the mixed dispersion may be, for example, (Tg−30° C.) or higher and (Tg° C.) or lower of the binder resin particles, where Tg is the glass transition temperature of the binder resin particles.

When the mixed dispersion contains two or more types of binder resin particles having different Tgs, the lowest temperature among the Tgs is defined as a Tg in the aggregation step.

### Second Aggregation Step

The second aggregation step involves attaching the amorphous resin particles (2) to the surfaces of the first aggregated particles to form the second aggregated particles. In other words, the second aggregation step is the step of forming the shell of the toner with a core-shell structure.

The second aggregation step includes, for example,
while stirring the dispersion containing the first aggregated particles, adding the dispersion containing the amorphous resin particles (2), which will constitute the shell, to mix two dispersions; and
heating the mixed dispersion while stirring the mixed dispersion.

The temperature reached by the mixed dispersion during heating of the mixed dispersion may be, for example, (Tg−30° C.) or higher and (Tg−10° C.) or lower of the amorphous resin particles (2), where Tg is the glass transition temperature of the amorphous resin particles (2), which will constitute the shell.

Before heating is performed in the coalescence step after the second aggregated particles have been grown to a predetermined size, a chelator for the aggregating agent used in the aggregation step may be added to the dispersion containing the second aggregated particles in order to terminate the growth of the second aggregated particles.

Examples of the chelator include oxycarboxylic acids, such as tartaric acid, citric acid, and gluconic acid; and aminocarboxylic acids, such as iminodiacetic acid (IDA), nitrilotriacetic acid (NTA), and ethylenediaminetetraacetic acid (EDTA).

The amount of the chelator added relative to 100 parts by mass of the binder resin particles is preferably 0.01 parts by mass or more and 5.0 parts by mass or less, more preferably 0.1 parts by mass or more and less than 3.0 parts by mass.

Before heating is performed in the coalescence step after the second aggregated particles have been grown to a predetermined size, the pH of the dispersion containing the second aggregated particles may be increased in order to terminate the growth of the second aggregated particles. The pH reached by the dispersion containing the second aggregated particles may be 8 or higher and 10 or lower.

Examples of the method for increasing the pH of the dispersion containing the second aggregated particles include, for example, adding at least one selected from the group consisting of aqueous solutions of alkali metal hydroxides and aqueous solutions of alkaline earth metal hydroxides.

### Coalescence Step

The coalescence step involves fusing and coalescing the aggregated particles into toner particles by heating the dispersion containing the second aggregated particles.

The temperature reached by the dispersion containing the second aggregated particles is preferably higher than or equal to the glass transition temperature (Tg) of the binder resin, specifically preferably a temperature higher than the Tg of the binder resin by 10° C. to 30° C.

When the aggregated particles contain two or more binder resins having different Tgs, the highest temperature among the Tgs is defined as a glass transition temperature in the coalescence step.

After completion of the coalescence step, the toner particles in the dispersion are subjected to a known washing step, a known solid-liquid separation step, and a known drying step to produce dry toner particles. The washing step may involve sufficient displacement washing with ion-exchanged water in view of charging characteristics. The solid-liquid separation step may involve, for example, suction filtration or pressure filtration in view of productivity. The drying step may involve, for example, freeze drying, airflow drying, fluidized bed drying, or vibrating fluidized bed drying in view of productivity.

### Step of Externally Adding External Additives

The toner production method according to the present disclosure may include a step of externally adding external additives to the toner particles.

The external addition of the external additives to the toner particles is carried out by mixing the dry toner particles and the external additives. Mixing is performed with a V-blender, a Henschel mixer, a Lodige mixer, or other mixers. In addition, coarse toner particles may be removed with a vibrating screening machine, a wind-power screening machine, or other machines, as necessary.

Examples of the external additives include inorganic particles. Examples of the inorganic particles include SiO₂, TiO₂, Al₂O₃, CuO, ZnO, SnO₂, CeO₂, Fe₂O₃, MgO, BaO, CaO, K₂O, Na₂O, ZrO₂, CaO·SiO₂, K₂O·(TiO₂)ₙ, Al₂O₃·2SiO₂, CaCO₃, MgCO₃, BaSO₄, MgSO₄, and SrTiO₃.

The surfaces of the inorganic particles serving as an external additive may be hydrophobized. Hydrophobization is performed by, for example, immersing the inorganic particles in a hydrophobizing agent. Examples of the hydrophobizing agent include, but are not limited to, a silane coupling agent, a silicone oil, a titanate coupling agent, and an aluminum coupling agent. These hydrophobizing agents may be used singly or in combination of two or more.

The amount of the hydrophobizing agent is normally, for example, 1 part by mass or more and 10 parts by mass or less relative to 100 parts by mass of the inorganic particles.

Examples of the external additives also include resin particles (resin particles made of, for example, polystyrene, polymethyl methacrylate, and melamine resin), and cleaning active agents (e.g., higher fatty acid metal salts, such as zinc stearate, and fluoropolymer particles).

The amount of the external additives externally added relative to the mass of the toner particles is preferably 0.01 mass % or more and 10 mass % or less, more preferably 0.01 mass % or more and 5 mass % or less.

### Toner for Developing Electrostatic Charge Images

The toner according to an exemplary embodiment of the present disclosure is produced by the toner production method according to the exemplary embodiment of the present disclosure.

The toner according to the exemplary embodiment of the present disclosure contains at least toner particles. The toner according to the exemplary embodiment of the present disclosure may contain toner particles and external additives. The forms of the external additives are as described above.

The toner particles constituting the toner according to the exemplary embodiment of the present disclosure are toner particles with a core-shell structure having a core containing the amorphous resin (1) and a shell covering the core and containing the amorphous resin (2).

The amorphous resin (1) has the same definition and the same preferred form as the amorphous resin constituting the amorphous resin particles (1).

The amorphous resin (2) has the same definition and the same preferred form as the amorphous resin constituting the amorphous resin particles (2).

The toner particles has a core-shell structure having a core containing at least the amorphous resin (1) and a shell containing at least the amorphous resin (2). The toner particles may contain a crystalline resin in the core. The toner particles may contain a release agent in the core. The toner particles may contain a colorant in the core. The toner particles may contain a crystalline resin, a release agent, and a colorant in the shell. The shell may have a multilayer structure. The type of resin and the physical properties, such as glass transition temperature (Tg) and SP value, as well as the presence or absence and type of colorant and release agent, may vary for each core and shell layer.

The amorphous resin (1) may be an amorphous polyester resin. The amorphous resin (2) may be an amorphous polyester resin.

The total amount of the amorphous polyester resin relative to the entire toner particles is preferably 40 mass % or more and 95 mass % or less, more preferably 50 mass % or more and 90 mass % or less, still more preferably 60 mass % or more and 85 mass % or less.

When the toner particles contain a crystalline resin, the crystalline resin may be a crystalline polyester resin. The amount of the crystalline polyester resin is preferably 3 mass % or more and 30 mass % or less, more preferably 8 mass % or more and 20 mass % or less of the total mass of the binder resin of the toner particles.

When the toner particles contain a release agent, the amount of the release agent relative to the entire toner particles is preferably 1 mass % or more and 20 mass % or less, more preferably 5 mass % or more and 15 mass % or less.

When the toner particles contain a colorant, the amount of the colorant relative to the entire toner particles is preferably 1 mass % or more and 30 mass % or less, more preferably 3 mass % or more and 15 mass % or less.

The volume-average particle size of the toner particles is preferably 2 μm or more and 10 μm or less, more preferably 4 μm or more and 8 μm or less. The method for measuring the volume-average particle size of the toner is as described below.

The particle size distribution of the toner is measured by using Coulter Multisizer 4c (available from Beckman Coulter, Inc.) and an electrolyte ISOTON-II (available from Beckman Coulter, Inc). Before measurement, 0.5 mg or more and 50 mg or less of a test sample is added to 2 ml of a 5 mass % aqueous solution of a surfactant (e.g., sodium alkylbenzene sulfonate) serving as a dispersant. The resulting mixture is added to 100 ml or more and 150 ml or less of the electrolyte. A suspension of the sample in the electrolyte is subjected to a dispersion treatment by using an ultrasonic disperser for 1 minute, and the particle size distribution of particles having a particle size in the range of 2 μm or more and 60 μm or less is measured by using Coulter Multisizer 4e with an aperture having a diameter of 100 μm. The number of sampled particles is 50,000. The particle size distribution is plotted from the smallest particle size, and the particle size at 50% cumulative volume is defined as a volume-average particle size D50v.

The average circularity of the toner particles is preferably 0.94 or more and 1.00 or less, more preferably 0.95 or more and 0.98 or less.

The average circularity of the toner particles is (the circumference of a circle having the same area as the projected particle image)/(the circumference of the projected particle image). The average circularity is determined by sampling 3500 particles using a flow particle image analyzer (Sysmex FPIA-3000).

### Electrostatic Charge Image Developer

An electrostatic charge image developer according to an exemplary embodiment contains at least the toner according to the exemplary embodiment. The electrostatic charge image developer according to the exemplary embodiment may be a one-component developer containing only a toner, or may be a two-component developer formed by mixing a toner and a carrier.

The carrier is not limited, and may be a known carrier. Examples of the carrier include a coated carrier obtained by coating, with a coating resin, the surface of a core made of magnetic powder; a magnetic powder-dispersed carrier in which a magnetic powder is dispersed and mixed in a matrix resin; and a resin-impregnated carrier in which a porous magnetic powder is impregnated with a resin.

The magnetic powder-dispersed carrier and the resin-impregnated carrier may be carriers in which particles constituting the carrier, which serve as cores, are coated with a coating resin.

Examples of the magnetic powder include powders made of magnetic metals, such as iron, nickel, and cobalt; and powders made of magnetic oxides, such as ferrite and magnetite.

Examples of the coating resin and the matrix resin include styrene-(meth)acrylate resin; polyolefin resins, such as polyethylene resin and polypropylene resin; polyvinyl or polyvinylidene resins, such as polystyrene, (meth)acrylic resin, polyacrylonitrile, polyvinyl acetate, polyvinyl alcohol, polyvinyl butyral, polyvinyl chloride, polyvinylcarbazole, polyvinyl ether, and polyvinyl ketone; vinyl chloride-vinyl acetate copolymer; straight silicone resin having organosiloxane bonds, and modified products thereof; fluororesins, such as polytetrafluoroethylene, polyvinyl fluoride, polyvinylidene fluoride, and polychlorotrifluoroethylene; polyester; polyurethane; polycarbonate; amino resins, such as urea-formaldehyde resin; and epoxy resin.

The coating resin and the matrix resin may contain a (meth)acrylic resin. The amount of the (meth)acrylic resin relative to the total mass of the resin is preferably 50 mass % or more, more preferably 80 mass % or more.

The coating resin and the matrix resin may contain an alicyclic (meth)acrylic resin as a (meth)acrylic resin.

The coating resin and the matrix resin may contain other additives, such as conductive particles. Examples of the conductive particles include particles made of metals, such as gold, silver, and copper; and particles made of carbon black, titanium oxide, zinc oxide, tin oxide, barium sulfate, aluminum borate, and potassium titanate.

The coating resin is formed on the surface of the core by, for example, a coating method using a coating layer-forming solution in which the coating resin and various optional additives are dissolved in an appropriate solvent. The solvent is not limited and may be selected in consideration of the coating resin used, coating suitability, and the like.

Specific examples of the resin coating method include an immersion method that involves immersing the core in the coating layer-forming solution; a spray method that involves spraying the coating layer-forming solution onto the surface of the core; a fluidized bed method that involves spraying the coating layer-forming solution onto the core while floating the core in air flow; and a kneader-coater method that involves mixing the core of the carrier and the coating layer-forming solution in a kneader-coater, and then removing the solvent.

The mixing ratio (mass ratio) of the toner to the carrier in the two-component developer is preferably from 1:100 to 30:100 (=toner:carrier), more preferably from 3:100 to 20:100.

### Image Forming Apparatus and Image Forming Method

An image forming apparatus according to an exemplary embodiment includes: an image holding member; a charging device that charges the surface of the image holding member; an electrostatic charge image-forming device that forms an electrostatic charge image on the charged surface of the image holding member; a developing device that stores an electrostatic charge image developer and develops the electrostatic charge image on the surface of the image holding member by using the electrostatic charge image developer to form a toner image; a transfer device that transfers the toner image on the surface of the image holding member to the surface of a recording medium; and a fixing device that fixes the toner image that has been transferred to the surface of the recording medium. The electrostatic charge image developer according to this exemplary embodiment is used as an electrostatic charge image developer.

An image forming method (an image forming method according to an exemplary embodiment) is carried out in the image forming apparatus according to this exemplary embodiment. The image forming method includes: a charging step of charging the surface of the image holding member; an electrostatic charge image forming step of forming an electrostatic charge image on the charged surface of the image holding member; a developing step of developing the electrostatic charge image on the surface of the image holding member by using the electrostatic charge image developer according to this exemplary embodiment to form a toner image; a transferring step of transferring the toner image on the surface of the image holding member to the surface of a recording medium; and a fixing step of fixing the toner image that has been transferred to the surface of the recording medium.

The image forming apparatus according to this exemplary embodiment may be a known image forming apparatus, such as a direct transfer-type apparatus in which a toner image formed on the surface of an image holding member is directly transferred to a recording medium; an intermediate transfer-type apparatus in which a toner image formed on the surface of an image holding member is first transferred to the surface of an intermediate transfer body, and the toner image, which has been transferred to the surface of the intermediate transfer medium, is second transferred to the surface of a recording medium; an apparatus including a cleaning device that cleans the surface of an image holding member before charging after transfer of a toner image; and an apparatus including a discharging device that discharges the surface of an image holding member by irradiating the surface of the image holding member with discharging light before charging after transfer of a toner image.

In an intermediate transfer-type apparatus, the transfer device includes, for example, an intermediate transfer body having the surface to which a toner image is transferred, a first transfer device that first transfers the toner image on the surface of the image holding member to the surface of the intermediate transfer body, and a second transfer device that second transfers the toner image, which has been transferred to the surface of the intermediate transfer body, to the surface of a recording medium.

In the image forming apparatus according to this exemplary embodiment, for example, a section including the developing device may be a cartridge structure (process cartridge) that is attachable to and detachable from the image forming apparatus. The process cartridge may be, for example, a process cartridge including a developing device that stores the electrostatic charge image developer according to this exemplary embodiment.

An example of the image forming apparatus according to the present exemplary embodiment will be described below, but the image forming apparatus is not limited to this example. The main parts shown in the figures will be described, and description of other parts is omitted.

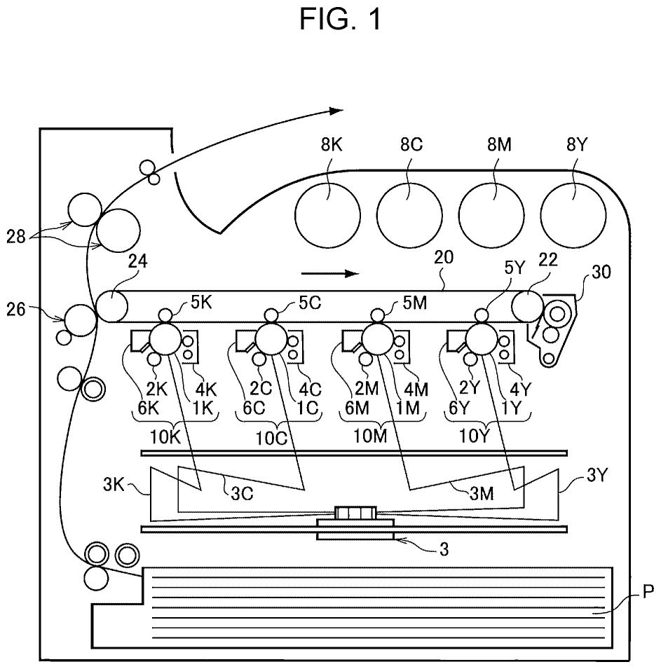

FIG. 1 is a schematic structural view of the image forming apparatus according to this exemplary embodiment.

The image forming apparatus shown in FIG. 1 includes first to fourth electrophotographic image forming units 10Y, 10M, 10C, and 10K, which respectively output yellow (Y), magenta (M), cyan (C), and black (K) color images based on color-separated image data. The image forming units (hereinafter may also be referred to simply as “units”) 10Y, 10M, 10C, and 10K are arranged and spaced apart from each other at predetermined intervals in the horizontal direction. The units 10Y, 10M, 10C, and 10K may be process cartridges that are attachable to and detachable from the image forming apparatus.

An intermediate transfer belt 20, which is an intermediate transfer body, passes through the units 10Y, 10M, 10C, and 10K and extends to run above the units 10Y, 10M, 10C, and 10K in the figure. The intermediate transfer belt 20 is wound around a drive roller 22 and a support roller 24 and runs in the direction from the first unit 10Y to the fourth unit 10K. The drive roller 22 and the support roller 24 are spaced apart from each other in the horizontal direction in the figure, and the support roller 24 is in contact with the inner surface of the intermediate transfer belt 20. The support roller 24 experiences a force in a direction away from the drive roller 22 by means of a spring or the like (not shown), so that tension is applied to the intermediate transfer belt 20 wound around the support roller 24 and the drive roller 22. An intermediate transfer body cleaning device 30 is disposed at the outer surface of the intermediate transfer belt 20 so as to face the drive roller 22.

Toners including four color toners of yellow, magenta, cyan, and black respectively contained in toner cartridges 8Y, 8M, 8C, and 8K are supplied to developing devices (examples of developing devices) 4Y, 4M, 4C, and 4K of units 10Y, 10M, 10C, and 10K.

Since the first to fourth units 10Y, 10M, 10C, and 10K have the same structure, the first unit 10Y disposed upstream in the running direction of the intermediate transfer belt to form a yellow image will be described as a representative example. The same parts as in the first unit 10Y are assigned with reference signs with magenta (M), cyan (C), and black (K) instead of yellow (Y), and therefore description of the second to fourth units 10M, 10C, and 10K is omitted.

The first unit 10Y has a photoreceptor 1Y, which functions as an image holding member. The photoreceptor 1Y is surrounded by, in sequence, a charging roller (an example of the charging device) 2Y, which charges the surface of the photoreceptor 1Y to a predetermined potential, an exposure device (an example of the electrostatic charge image-forming device) 3, which exposes the charged surface to a laser beam 3Y based on a color-separated image signal to form an electrostatic charge image, a developing device (an example of the developing device) 4Y, which supplies charged toner to the electrostatic charge image to develop the electrostatic charge image, a first transfer roller (an example of the first transfer device) 5Y, which transfers the developed toner image to the intermediate transfer belt 20, and a photoreceptor cleaning device (an example of the cleaning device) 6Y, which removes toner remaining on the surface of the photoreceptor 1Y after the first transfer.

The first transfer roller 5Y is disposed on the inner side of the intermediate transfer belt 20 so as to face the photoreceptor 1Y. The first transfer rollers 5Y, 5M, 5C, and 5K are connected to the respective bias power sources (not shown) that apply a first transfer bias. The transfer bias applied by each bias power source to the corresponding first transfer roller changes under the control of a controller (not shown).

The operation of the first unit 10Y in forming a yellow image will be described below.

Before operation, the charging roller 2Y charges the surface of the photoreceptor 1Y to a potential of −600 V to −800 V.

The photoreceptor 1Y includes a conductive substrate (e.g., a volume resistivity of 1×10⁶ Ωcm or less at 20° C.) and a photosensitive layer stacked on the substrate. The photosensitive layer normally has high resistance (resistance of common resin) but, upon irradiation with the laser beam 3Y, changes its specific resistance in a laser beam-irradiated region. For this, the charged surface of the photoreceptor 1Y is exposed to the laser beam 3Y through the exposure device 3 in accordance with yellow image data sent from the controller (not shown). The photosensitive layer on the surface of the photoreceptor 1Y is irradiated with the laser beam 3Y to form an electrostatic charge image with a yellow image pattern on the surface of the photoreceptor 1Y.

The electrostatic charge image is formed on the surface of the photoreceptor 1Y by charging. The electrostatic charge image is a so-called negative latent image formed when the laser beam 3Y reduces the specific resistance of the irradiated portion of the photosensitive layer to cause the charge on the surface of the photoreceptor 1Y to flow while the charge on a portion not irradiated with the laser beam 3Y remains.

The electrostatic charge image formed on the photoreceptor 1Y rotates to a predetermined developing position as the photoreceptor 1Y runs. At this developing position, the electrostatic charge image on the photoreceptor 1Y is visualized (developed) by the developing device 4Y to form a toner image.

The developing device 4Y stores, for example, an electrostatic charge image developer containing at least a yellow toner and a carrier. The yellow toner is triboelectrically charged by stirring inside the developing device 4Y so as to have a charge with the same polarity (negative polarity) as the charge on the photoreceptor 1Y and held on a developer roller (an example of a developer holding member). As the surface of the photoreceptor 1Y passes through the developing device 4Y, the yellow toner electrostatically adheres to discharged latent image areas on the surface of the photoreceptor 1Y, whereby the latent image is developed by the yellow toner. The photoreceptor 1Y having the yellow toner image formed thereon subsequently runs at a predetermined speed, and the toner image developed on the photoreceptor 1Y is transported to a predetermined first transfer position.

When the yellow toner image on the photoreceptor 1Y is transported to the first transfer position, a first transfer bias is applied to the first transfer roller 5Y so that an electrostatic force from the photoreceptor 1Y toward the first transfer roller 5Y acts on the toner image, transferring the toner image on the photoreceptor 1Y to the intermediate transfer belt 20. The transfer bias applied at this time has polarity (+) opposite to the polarity (−) of the toner and is controlled at, for example, +10 μA in the first unit 10Y by the controller (not shown).

The toner remaining on the photoreceptor 1Y is removed and collected by the photoreceptor cleaning device 6Y.

The first transfer biases applied to the first transfer rollers 5M, 5C, and 5K in the second unit 10M and the subsequent units are also controlled in accordance with the first unit.

Accordingly, the intermediate transfer belt 20 to which the yellow toner image has been transferred in the first unit 10Y is transported through the second to fourth units 10M, 10C, and 10K, and the toner images of respective colors are transferred in a superimposed manner.

The intermediate transfer belt 20 to which the four color toner images have been transferred through the first to fourth units reaches a second transfer section including the intermediate transfer belt 20, the support roller 24 in contact with the inner surface of the intermediate transfer belt, and a second transfer roller (an example of the second transfer device) 26 disposed adjacent to the outer surface of the intermediate transfer belt 20. A sheet of recording paper (an example of the recording medium) P is fed to a gap between the second transfer roller 26 and the intermediate transfer belt 20 through a feeding mechanism at a predetermined timing, and a second transfer bias is applied to the support roller 24. The transfer bias applied at this time has the same polarity (−) as the polarity (−) of the toner, and an electrostatic force from the intermediate transfer belt 20 toward the sheet of recording paper P acts on the toner image, transferring the toner image on the intermediate transfer belt 20 to the sheet of recording paper P. The second transfer bias in this case is determined on the basis of the resistance detected by a resistance detector (not shown) that detects the resistance of the second transfer section, and the second transfer bias is voltage-controlled.

The sheet of recording paper P is then conveyed to a pressure contact part (nip part) between a pair of fixing rollers in a fixing device (an example of the fixing device) 28. The toner image is thus fixed to the sheet of recording paper P to form a fixed image.

Examples of the recording paper P to which a toner image is transferred include plain paper used in electrophotographic copiers, printers, and the like. Examples of the recording medium include OHP sheets, in addition to the recording paper P.

To further improve the smoothness of the image surface after fixing, the recording paper P may have a smooth surface and may be, for example, coated paper obtained by coating the surface of plain paper with resin or the like, art paper for printing, or the like.

The sheet of recording paper P to which the color image has been fixed is discharged to a discharge unit, and a series of color image forming operations are completed.

### Process Cartridge and Toner Cartridge

A process cartridge according to an exemplary embodiment is a process cartridge attachable to and detachable from an image forming apparatus. The process cartridge includes a developing device that stores the electrostatic charge image developer according to this exemplary embodiment and that develops an electrostatic charge image on the surface of an image holding member by using the electrostatic charge image developer to form a toner image.

The process cartridge according to this exemplary embodiment is not limited to the foregoing structure and may include a developing device and, as desired, for example, at least one selected from an image holding member, a charging device, an electrostatic charge image-forming device, a transfer device, and other devices.

An example of the process cartridge according to this exemplary embodiment will be described below, but the process cartridge is not limited to this example. The main parts shown in the figures will be described, and description of other parts is omitted.

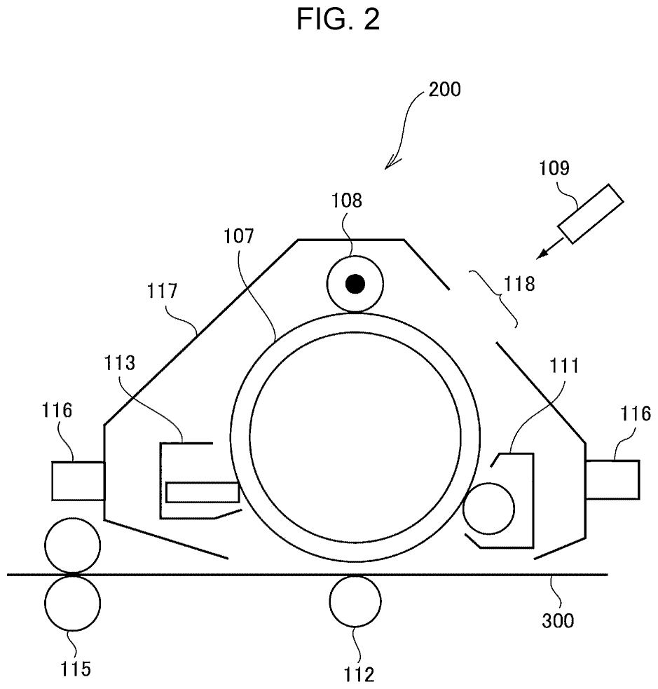

FIG. 2 is a schematic structural view of the process cartridge according to this exemplary embodiment.

A process cartridge 200 shown in FIG. 2 is configured as a cartridge in such a manner that, for example, a photoreceptor 107 (an example of the image holding member) and, around the photoreceptor 107, a charging roller 108 (an example of the charging device), a developing device 111 (an example of the developing device), and a photoreceptor cleaning device 113 (an example of the cleaning device) are integrally combined and held together by a housing 117 including an installation rail 116 and an opening 118 for exposure.

In FIG. 2, the reference numeral 109 represents an exposure device (an example of the electrostatic charge image-forming device), the reference numeral 112 represents a transfer device (an example of the transfer device), the reference numeral 115 represents a fixing device (an example of the fixing device), and the reference numeral 300 represents a sheet of recording paper (an example of the recording medium).

The toner cartridge according to this exemplary embodiment stores the toner according to this exemplary embodiment and is attachable to and detachable from an image forming apparatus. The toner cartridge stores toner for replenishment to be supplied to the developing device in the image forming apparatus.

The image forming apparatus shown in FIG. 1 has attachable/detachable toner cartridges 8Y, 8M, 8C, and 8K. The developing devices 4Y, 4M, 4C, and 4K are connected to the respective toner cartridges corresponding to the developing devices (colors) through toner feed tubes (not shown). When the toners stored in the toner cartridges run short, these toner cartridges are replaced.

### EXAMPLES

Exemplary embodiments will be described below in detail by way of Examples, but exemplary embodiments are not limited to these Examples.

In the following description, the units “part” and “%” are on a mass basis, unless otherwise specified.

In the following description, synthesis, production, treatment, measurement, and other processes are carried out at room temperature (25° C.±3° C.), unless otherwise specified.

### Preparation of Amorphous Polyester Resin (a)

Terephthalic acid: 90 parts
Fumaric acid: 10 parts
Propylene oxide 2-mol adduct of Bisphenol A: 95 parts
Neopentyl glycol: 5 parts

The materials described above are placed in a flask equipped with a stirrer, a nitrogen inlet tube, a temperature sensor, and a fractionating column. The temperature is increased to 210° C. over 1 hour, and 1 part of titanium tetraethoxide is fed to 100 parts of the above materials. While generated water is distilled off, the mixture is heated to 230° C. over 0.5 hours, and the dehydration condensation reaction continues at 230° C. for 1 hour. The reaction product is then cooled. An amorphous polyester resin (a) having a weight-average molecular weight (Mw) of 18,000, a glass transition temperature of 60° C., and an acid value of 12.0 mgKOH/g is produced accordingly.

### Preparation of Crystalline Polyester Resin (b)

Sebacic acid: 279 parts
1,6-Hexanediol: 163 parts
Dibutyltin oxide (catalyst): 0.7 parts

The materials described above are placed in a heat-dried three-necked flask, and the air in the three-necked flask is converted into an inert atmosphere by replacement with nitrogen gas. The mixture is stirred and refluxed at 180° C. for 6 hours by mechanical stirring. A crystalline polyester resin (b) having a weight-average molecular weight (Mw) of 29,000 and an acid value of 8.8 mgKOH/g is produced accordingly.

### Preparation of Amorphous Polyester Resin Particle Dispersion (1)

### Amorphous Polyester Resin Particle Dispersion (1-1)

The following materials are prepared.
Amorphous polyester resin (a) (weight-average molecular weight 18,000, glass transition temperature 60° C., and acid value 12.0 mgKOH/g): 500 parts
Basic compound: 25% aqueous solution of sodium hydroxide: 7.7 parts
Surfactant: 48.5% aqueous solution of sodium dodecyl diphenyl ether disulfonate (product name: Eleminol MON-7, Sanyo Chemical Industries, Ltd.): 17.0 parts
Ion-exchanged water (1): ion-exchanged water at temperature of 85° C.: 125 parts
Ion-exchanged water (2): ion-exchanged water at temperature of 85° C.: 125 parts
Ion-exchanged water (3): ion-exchanged water at temperature of 85° C.: 125 parts

A twin-screw extruder (model: TEM 26SS, Toshiba Machine Co., Ltd.) is provided. The barrel of the twin-screw extruder used in this Example includes multiple barrel blocks connected to each other.

### Melting Step

The barrel temperature of the twin-screw extruder is set to 85° C., and the number of rotation of the screw is set to 400 rpm. The amorphous polyester resin and the basic compound are fed through the material feed port of the twin-screw extruder, and the operation of the twin-screw extruder is started. The surfactant is fed from the fourth barrel block and kneaded, and the resin is melted to produce a mixture.

### Dispersing Step

While the twin-screw extruder is operated so that the average feed rate of the mixture is 12 kg/h, the ion-exchanged water (1) is fed from the fifth barrel block, the ion-exchanged water (2) is fed from the seventh barrel block, the ion-exchanged water (3) is fed from the ninth barrel block, and the mixture is dispersed in an aqueous medium to obtain an amorphous polyester resin particle dispersion (1-1). The solid concentration of the amorphous polyester resin particle dispersion (1-1) is 30%.

The particle size distribution of the particles in the resin particle dispersion is measured by a laser diffraction-type particle size distribution analyzer (model: LS13-320, Beckman Coulter, Inc). The volume-average particle size D50v at 50% cumulative volume from the smallest particle size in the volume-based particle size distribution is determined. D16v at 16% cumulative volume from the smallest particle size and D84v at 84% cumulative volume from the smallest particle size are determined, and the particle size distribution index GSDv is calculated using formula (2) below. The measurement results are shown in Table 1.

$$GSDv = {( D 84 v / D 16 v )}^{1 / 2} \qquad Formula ( 2 )$$

The elemental sulfur content (the mass percentage of elemental sulfur relative to the mass of the amorphous polyester resin) in the amorphous polyester resin particles (1-1) is determined by the measurement method using the X-ray fluorescence analysis described above. The elemental sulfur content is described in Table 1.

### Amorphous Polyester Resin Particle Dispersions (1-2) to (1-4)

An amorphous polyester resin particle dispersion of each Example is prepared in the same manner as in the production of the amorphous polyester resin particle dispersion (1-1), except that the amounts of materials used are changed as described in Table 1.

TABLE 1

| | | | | | Total | | | |
|---|---|---|---|---|---|---|---|---|
| | | | | | amount of | Volume- | | |
| Amorphous | Amorphous | | | | ion- | average | | |
| polyester resin | polyester | Basic | | | exchanged | particle | | Elemental |
| particle | resin | compound | Neutralization | Surfactant | water | size | | sulfur |
| dispersion (1) | part by | part by | ratio | part by | part by | D50v | GSDv | content |
| No. | mass | mass | % | mass | mass | nm | — | mass % |
| (1-1) | 500 | 7.7 | 45 | 17.1 | 375 | 200 | 1.24 | 0.12 |
| (1-2) | 500 | 5.2 | 30 | 20.6 | 375 | 210 | 1.25 | 0.16 |
| (1-3) | 500 | 5.2 | 30 | 31.8 | 375 | 190 | 1.23 | 0.20 |
| (1-4) | 500 | 5.2 | 30 | 45.6 | 375 | 170 | 1.21 | 0.25 |

Preparation of Amorphous Polyester Resin Particle Dispersion (2)
Amorphous Polyester Resin Particle Dispersion (2-1)

The following materials are prepared.
Organic solvent (1): ethyl acetate: 60 parts
Organic solvent (2): isopropanol: 24 parts
Amorphous polyester resin (a) (weight-average molecular weight 18,000, glass transition temperature 60° C., and acid value 12.0 mgKOH/g): 100 parts
Basic compound: 10% ammonia water: 3.3 parts
Ion-exchanged water (4): ion-exchanged water at temperature of 40° C.: 500 parts

### Step (1)

The organic solvent (1) and the organic solvent (2) are fed to a stirring tank equipped with a stirrer, a condenser, a heater, and a thermometer to prepare a mixed solvent. While the mixed solvent is stirred with the temperature in the stirring tank maintained at 50° C., the amorphous polyester resin is fed and stirred for 30 minutes to dissolve the resin in the organic solvent.

### Dispersing Step

While the temperature in the stirring tank is maintained and stirring is continued, 10% ammonia water is fed, and the ion-exchanged water (4) is next added dropwise to disperse the contents in the aqueous medium. After the heating of the stirring tank is stopped and the temperature of the dispersion is lowered to room temperature, the organic solvent is removed from the dispersion by reducing the pressure in the stirring tank. The dispersion is passed through a sieve to obtain an amorphous polyester resin particle dispersion (2-1). The solid concentration of the amorphous polyester resin particle dispersion (2-1) is 30%.

The particle size distribution of the particles in the amorphous polyester resin particle dispersion (2-1) is measured by a laser diffraction-type particle size distribution analyzer (model: LS13-320, Beckman Coulter, Inc). The volume-average particle size D50v and the particle size distribution index GSDv are described in Table 2.

The elemental sulfur content (the mass percentage of elemental sulfur relative to the mass of the amorphous polyester resin) in the amorphous polyester resin particles (2-1) is determined by the measurement method using the X-ray fluorescence analysis described above. The elemental sulfur content is described in Table 2.

### Amorphous Polyester Resin Particle Dispersion (2-2)

To the amorphous polyester resin particle dispersion (2-1), 0.8 parts of a 48.5% aqueous solution of sodium dodecyl diphenyl ether disulfonate surfactant (product name: Eleminol MON-7, Sanyo Chemical Industries, Ltd.) is added. The mixture is maintained at 60° C. for 1 hour to produce an amorphous polyester resin particle dispersion (2-2) described in Table 2.

TABLE 2

| | | | | | Total | | | |
|---|---|---|---|---|---|---|---|---|
| | | | | | amount of | Volume- | | |
| Amorphous | Amorphous | | | | ion- | average | | |
| polyester resin | polyester | Basic | | | exchanged | particle | | Elemental |
| particle | resin | compound | Neutralization | Surfactant | water | size | | sulfur |
| dispersion (2) | part by | part by | ratio | part by | part by | D50v | GSDv | content |
| No. | mass | mass | % | mass | mass | nm | — | mass % |
| (2-1) | 100 | 3.3 | 91 | 0 | 500 | 180 | 1.22 | 0.00 |
| (2-2) | 100 | 3.3 | 91 | 0.8 | 500 | 180 | 1.22 | 0.10 |

Preparation of Crystalline Polyester Resin Particle Dispersion (1)

Crystalline polyester resin (b) (weight-average molecular weight 29,000, and acid value 8.8 mgKOH/g): 100 parts
Methyl ethyl ketone: 70 parts
Isopropanol: 12 parts
10% Ammonia aqueous solution: 3 parts

The materials described above are fed to a reaction vessel equipped with a condenser, a thermometer, a dropping device, and an anchor blade, and mixed by stirring at 100 rpm to dissolve the crystalline polyester resin while the liquid temperature is maintained at 80° C. in a water-circulation thermostatic bath. Next, the water-circulation thermostatic bath is set to 60° C., and a total of 300 parts of ion-exchanged water maintained at 60° C. is added dropwise at a rate of 3 parts/min to cause phase inversion and thus to form a dispersion. The dispersion is placed in a round-bottom flask, and the round-bottom flask is set in an evaporator equipped with a vacuum control unit via a trap bulb. The solvent is removed by heating the round-bottom flask in a water bath at 60° C. while rotating the round-bottom flask, and reducing the pressure to 7 kPa while paying attention to bumping. The pressure is then returned to normal pressure, and the round-bottom flask is cooled with water to provide a dispersion. Ion-exchanged water is added to the dispersion to provide a crystalline polyester resin particle dispersion (1) with a solids content of 20 mass %. The volume-average particle size of the crystalline polyester resin particles is 160 nm.

### Preparation of Release Agent Particle Dispersion (1)

Paraffin wax (HNP-9, Nippon Seiro Co., Ltd.): 20 parts
Ion-exchanged water: 80 parts
Anionic surfactant: (20% aqueous solution of dodecylbenzenesulfonic acid, Neogen RK, DKS Co. Ltd.): 1 part

The materials described above are mixed and heated to 100° C. The mixture is dispersed by using a homogenizer (ULTRA-TURRAX T50, IKA) and then dispersed by using a pressure discharge-type homogenizer (Manton-Gaulin high-pressure homogenizer, Gaulin Corporation). The resulting dispersion is collected when the volume-average particle diameter reaches 200 nm. An appropriate amount of ion-exchanged water is added to provide a release agent particle dispersion (1) with a solid concentration of 20%.

### Preparation of Colorant Particle Dispersion (1)

Cyan pigment (C.I. Pigment Blue 15:3, Dainichiseika Color & Chemicals Mfg. Co., Ltd.): 20 parts
Ion-exchanged water: 80 parts
Anionic surfactant: (20% aqueous solution of dodecylbenzenesulfonic acid, Neogen RK, DKS Co. Ltd.): 1 part

The materials described above are mixed and dispersed with a high-pressure impact disperser (Altimizer HJP30006, Sugino Machine Limited) for 1 hour, and the resulting dispersion is collected when the volume-average particle size reaches 180 nm. An appropriate amount of ion-exchanged water is added to provide a colorant particle dispersion (1) with a solid concentration of 20%.

### Example 1: Production of Toner and Developer

### Preparation of Toner Particles

### First Aggregation Step

Ion-exchanged water: 50 parts
Amorphous polyester resin particle dispersion (1-1): 30 parts
Crystalline polyester resin particle dispersion (1): 13 parts
Release agent particle dispersion (1): 10 parts
Colorant particle dispersion (1): 11 parts
Anionic surfactant: (20% aqueous solution of dodecylbenzenesulfonic acid, Neogen RK, DKS Co. Ltd.): 1 part
1% Aqueous solution of ammonium sulfate: 1.8 parts

The materials described above are placed in a round stainless steel flask. The mixture is adjusted to pH 3.5 by adding 0.1N nitric acid, and 30 parts of a nitric acid aqueous solution with 10% polyaluminum chloride is then added. The liquid temperature is controlled at 30° C. using an oil bath, and the mixture is dispersed using a homogenizer (ULTRA TURRAX T50, IKA). Next, the liquid temperature is increased to 45° C. and maintained for 160 minutes to form first aggregated particles.

### Second Aggregation Step

While the liquid temperature of the dispersion containing the first aggregated particles is maintained at 45° C., 20 parts of the amorphous polyester resin particle dispersion (2-1) is added, and the mixture is held for 10 minutes to form second aggregated particles.

### Coalescence Step

The pH is adjusted to 8.7 by adding a 0.1 N aqueous solution of sodium hydroxide to the dispersion containing the second aggregated particles, and the liquid temperature is increased to 84° C. and held for 80 minutes. The dispersion is then cooled to 20° C. at a rate of 20° C./min, and the solids are filtered, washed with ion-exchanged water, and dried. The dried material is sieved to obtain toner particles (1).

Preparation of Toner with External Additive

Hydrophobic silica particles (product number: RY50, Nippon Aerosil Co., Ltd.) (1.5 parts) are added to 100 parts of the toner particles (1) and mixed by using a sample mill at 10,000 rpm for 30 seconds. The mixture is then sieved through a vibrating screen with a mesh size of 45 μm to provide a toner with an external additive.

### Preparation of Carrier (1)

A dispersion is prepared by placing 14 parts of toluene, 5 parts of cyclohexyl methacrylate-monoethylaminoethyl methacrylate copolymer (mass ratio 95:5, weight-average molecular weight 60,000), and 0.2 parts of carbon black (product number: VXC-72, Cabot Japan Inc.) in a sand mill and performing a dispersion treatment. The dispersion and 100 parts of ferrite particles (average particle size 35 μm) are placed in a vacuum degassing kneader and dried under reduced pressure with stirring to provide a carrier (1).

### Preparation of Developer

Eight parts of the toner with the external additive and 92 parts of the carrier (1) are placed in a V-blender and stirred for 20 minutes. The mixture is then sieved through a screen with a mesh size of 212 μm to provide a developer.

### Examples 2 to 18 and Comparative Examples 1 to 2

Toner particles of each Example are prepared in the same manner as in Example 1 except that the type of amorphous polyester resin particle dispersion (1) and the type of amorphous polyester resin particle dispersion (2) are changed as described in Table 3, and the amounts of the anionic surfactant and the aqueous solution of ammonium sulfate added and the pH in the coalescence step are changed as described in Table 3. The toner with the external additive and the developer are produced in the same manner as in Example 1 using the toner particles of each Example.

### Evaluation

### Particle Size Distribution of Toner Particles

The particle size distribution of the toner particles is measured by using Coulter Multisizer 4e (Beckman Coulter, Inc). The volume-average particle size D50v at 50% cumulative volume from the smallest particle size in the volume-based particle size distribution is determined. D16v at 16% cumulative volume from the smallest particle size and D84v at 84% cumulative volume from the smallest particle size are determined, and the particle size distribution index GSDv is calculated using formula (2) below. The measurement results are shown in Table 3.

$$GSDv = {( D 84 v / D 16 v )}^{1 / 2} \qquad Formula ( 2 )$$

### Analysis of Elemental Sulfur

The elemental sulfur content (mass %) is determined by the X-ray fluorescence analysis described above using the toner particles before external addition as a sample. The measurement results are shown in Table 3.

### Evaluation of Image Density Unevenness

A4 size plain paper (Fujifilm Business Innovation Corporation, C2 paper) is placed in an environment with a temperature of 25° C. and a relative humidity of 50% for one week for temperature and humidity control.

A developing device in a modified version of image forming apparatus “700 Digital Color Press” (Fujifilm Business Innovation Corporation) is filled with a developer, and the image forming apparatus is seasoned overnight in an environment with a temperature of 25° C. and a relative humidity of 50%. Next, a 20 cm×20 cm patch image with an image density of 1.6 is formed on the temperature- and humidity-controlled plain paper, and the image formation conditions are stored in the image forming device. The image density is measured with a reflection spectrodensitometer X-Rite 939 (aperture 4 mm, X-Rite Inc).

After the image forming apparatus has been seasoned in an environment with a temperature of 28° C. and a relative humidity of 90% for one day, a 20 cm×20 cm patch image is printed on a sheet of the temperature- and humidity-controlled plain paper at a transfer voltage of 1200 V in an environment with a temperature of 28° C. and a relative humidity of 90%. The image density is measured at 5 locations, and the difference (A image density) between the maximum image density and the minimum image density is classified as described below. The evaluation results are shown in Table 3.

A: Δ Image density is 0.05 or less.

B+: Δ Image density is more than 0.05 and 0.10 or less.

B: Δ Image density is more than 0.10 and 0.15 or less.

B−: Δ Image density is more than 0.15 and 0.20 or less.

C: Δ Image density is more than 0.20 and 0.25 or less.

D: Δ Image density is more than 0.25.

TABLE 3

| | Amorphous polyester | | Amorphous polyester | | | | |
|---|---|---|---|---|---|---|---|
| | resin particle | | resin particle | | | | |
| | dispersion (1) | | dispersion (2) | | | | |
| | | Elemental | | Elemental | | | |
| | | sulfur | | sulfur | | | |
| | | content S(1) | | content S(2) | First aggregation step | | |
| | | relative to | | relative to | | Aqueous | |
| | | mass of | | mass of | | solution of | |
| | | amorphous | | amorphous | Anionic | ammonium | Coalescence |
| | Type | resin | Type | resin | surfactant | sulfate | step |
| | No. | mass % | No. | mass % | part | part | pH |
| Example 1 | (1-1) | 0.12 | (2-1) | 0.00 | 1.0 | 1.8 | 8.7 |
| Example 2 | (1-2) | 0.16 | (2-1) | 0.00 | 1.0 | 2.2 | 8.6 |
| Example 3 | (1-1) | 0.12 | (2-1) | 0.00 | 0.4 | 0.8 | 8.9 |
| Example 4 | (1-1) | 0.12 | (2-1) | 0.00 | 0.8 | 0.8 | 8.8 |
| Example 5 | (1-3) | 0.20 | (2-1) | 0.00 | 1.4 | 2.2 | 8.8 |
| Example 6 | (1-3) | 0.20 | (2-1) | 0.00 | 1.5 | 2.2 | 8.8 |
| Comparative | (1-1) | 0.12 | (2-1) | 0.00 | 0.4 | 0.8 | 8.2 |
| Example 1 | | | | | | | |
| Comparative | (1-1) | 0.12 | (2-1) | 0.00 | 1.6 | 2.2 | 9.6 |
| Example 2 | | | | | | | |
| Example 7 | (1-4) | 0.25 | (2-1) | 0.00 | 0.4 | 2.2 | 8.2 |
| Example 8 | (1-4) | 0.25 | (2-1) | 0.00 | 0.4 | 2.2 | 8.4 |
| Example 9 | (1-1) | 0.12 | (2-1) | 0.00 | 0.9 | 1.8 | 9.0 |
| Example 10 | (1-1) | 0.12 | (2-1) | 0.00 | 1.1 | 2.2 | 9.0 |
| Example 11 | (1-1) | 0.12 | (2-1) | 0.00 | 1.2 | 2.2 | 9.0 |
| Example 12 | (1-1) | 0.12 | (2-1) | 0.00 | 1.0 | 0.1 | 8.7 |
| Example 13 | (1-1) | 0.12 | (2-1) | 0.00 | 1.0 | 0.2 | 8.7 |
| Example 14 | (1-1) | 0.12 | (2-1) | 0.00 | 1.0 | 0.3 | 8.7 |
| Example 15 | (1-1) | 0.12 | (2-1) | 0.00 | 1.0 | 2.9 | 8.7 |
| Example 16 | (1-1) | 0.12 | (2-1) | 0.00 | 1.0 | 3.7 | 8.7 |
| Example 17 | (1-1) | 0.12 | (2-1) | 0.00 | 1.0 | 4.0 | 8.7 |
| Example 18 | (1-2) | 0.16 | (2-2) | 0.10 | 0.9 | 2.2 | 8.6 |

| | Toner particles | | | | | | |
|---|---|---|---|---|---|---|---|
| | Particle size | | | | | | |
| | distribution | | Elemental sulfur | Elemental | | | |
| | Volume- | | content S(T) of | sulfur | | | |
| | average | | toner particles | content | | | Image |
| | particle | | relative to mass | N(T) in | S(T)/ | N(T)/ | density |
| | size | GSDv | of toner particles | surface | S(1) | S(T) | unevenness |
| | μm | — | mass % | ppm | — | ppm/mass % | — |
| Example 1 | 5.1 | 1.22 | 0.10 | 3.0 | 0.8 | 30 | A |
| Example 2 | 5.2 | 1.21 | 0.13 | 3.5 | 0.8 | 27 | A |
| Example 3 | 5.2 | 1.23 | 0.05 | 1.4 | 0.4 | 28 | C |
| Example 4 | 5.1 | 1.22 | 0.08 | 1.4 | 0.7 | 18 | B |
| Example 5 | 5.1 | 1.21 | 0.18 | 3.5 | 0.9 | 19 | B |
| Example 6 | 5.0 | 1.21 | 0.20 | 3.5 | 1.0 | 18 | C |
| Comparative | 5.4 | 1.31 | 0.04 | 1.4 | 0.3 | 35 | D |
| Example 1 | | | | | | | |
| Comparative | 5.0 | 1.20 | 0.22 | 3.5 | 1.8 | 16 | D |
| Example 2 | | | | | | | |
| Example 7 | 5.3 | 1.25 | 0.10 | 3.5 | 0.4 | 35 | B |
| Example 8 | 5.3 | 1.22 | 0.15 | 3.5 | 0.6 | 23 | B+ |
| Example 9 | 5.1 | 1.21 | 0.11 | 3.0 | 0.9 | 27 | B+ |
| Example 10 | 5.1 | 1.21 | 0.12 | 3.5 | 1.0 | 29 | B |
| Example 11 | 5.0 | 1.21 | 0.14 | 3.5 | 1.2 | 25 | B− |
| Example 12 | 5.1 | 1.22 | 0.10 | 0.2 | 0.8 | 2 | B− |
| Example 13 | 5.1 | 1.22 | 0.10 | 0.4 | 0.8 | 4 | B |
| Example 14 | 5.1 | 1.22 | 0.10 | 0.6 | 0.8 | 6 | B+ |
| Example 15 | 5.1 | 1.22 | 0.10 | 4.0 | 0.8 | 40 | B+ |
| Example 16 | 5.1 | 1.22 | 0.10 | 5.0 | 0.8 | 50 | B |
| Example 17 | 5.1 | 1.22 | 0.10 | 5.3 | 0.8 | 53 | B− |
| Example 18 | 5.2 | 1.20 | 0.13 | 3.5 | 0.8 | 27 | A |

The method for producing a toner for developing electrostatic charge images, the toner for developing electrostatic charge images, the electrostatic charge image developer, the toner cartridge, the process cartridge, the image forming apparatus, and the image forming method according to exemplary embodiments of the present disclosure include the following exemplary embodiments.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1))) A method for producing a toner for developing electrostatic charge images, the method including:
forming first aggregated particles by aggregating amorphous resin particles (1), which are obtained by melt-mixing an amorphous resin and adding an aqueous medium to effect granulation, in a resin particle dispersion containing the amorphous resin particles (1);
forming second aggregated particles by attaching amorphous resin particles (2), which are obtained by dissolving and mixing an amorphous resin with an organic solvent and adding an aqueous medium to effect granulation, to surfaces of the first aggregated particles in a resin particle dispersion containing the first aggregated particles and the amorphous resin particles (2); and
fusing and coalescing the second aggregated particles into toner particles by heating a dispersion containing the second aggregated particles,
wherein the toner particles contain elemental sulfur, and an elemental sulfur content in the toner particles is 0.05 mass % or more and 0.20 mass % or less relative to a mass of the toner particles.

(((2))) The method for producing a toner for developing electrostatic charge images according to (((1))), wherein:
the amorphous resin particles (1) contain elemental sulfur, and
a value obtained by dividing the elemental sulfur content in the toner particles (a mass percentage of elemental sulfur relative to the mass of the toner particles) by an elemental sulfur content in the amorphous resin particles (1) (a mass percentage of elemental sulfur relative to a mass of an amorphous resin of the amorphous resin particles (1)) is 1 or less.

(((3))) The method for producing a toner for developing electrostatic charge images according to (((1))) or (((2))), wherein:
the toner particles contain elemental nitrogen, and
a value (ppm/mass %) obtained by dividing an elemental nitrogen content (ppm) in surfaces of the toner particles by the elemental sulfur content (mass %) in the toner particles is 50 or less.

(((4))) A toner for developing electrostatic charge images, the toner being produced by the method for producing a toner for developing electrostatic charge images according to any one of (((1))) to (((3))).

(((5))) An electrostatic charge image developer containing the toner for developing electrostatic charge images according to (((4))).

(((6))) A toner cartridge attachable to and detachable from an image forming apparatus,
wherein the toner cartridge stores the toner for developing electrostatic charge images according to (((4))).

(((7))) A process cartridge attachable to and detachable from an image forming apparatus,
wherein the process cartridge includes a developing device that stores the electrostatic charge image developer according to (((5))) and that develops an electrostatic charge image on a surface of an image holding member by using the electrostatic charge image developer to form a toner image.

(((8))) An image forming apparatus including:
an image holding member;
a charging device that charges a surface of the image holding member;
an electrostatic charge image-forming device that forms an electrostatic charge image on the charged surface of the image holding member;
a developing device that stores the electrostatic charge image developer according to (((5))) and develops the electrostatic charge image on the surface of the image holding member by using the electrostatic charge image developer to form a toner image;
a transfer device that transfers the toner image on the surface of the image holding member to a surface of a recording medium; and
a fixing device that fixes the toner image that has been transferred to the surface of the recording medium.

(((9))) An image forming method including:
charging a surface of an image holding member,
forming an electrostatic charge image on the charged surface of the image holding member;
developing the electrostatic charge image on the surface of the image holding member by using the electrostatic charge image developer according to (((5))) to form a toner image;
transferring the toner image on the surface of the image holding member to a surface of a recording medium; and
fixing the toner image that has been transferred to the surface of the recording medium.

What is claimed is:

1. A method for producing a toner for developing electrostatic charge images, the method comprising:
forming first aggregated particles by aggregating amorphous resin particles (1), which are obtained by melt-mixing an amorphous resin and adding an aqueous medium to effect granulation, in a resin particle dispersion containing the amorphous resin particles (1);
forming second aggregated particles by attaching amorphous resin particles (2), which are obtained by dissolving and mixing an amorphous resin with an organic solvent and adding an aqueous medium to effect granulation, to surfaces of the first aggregated particles in a resin particle dispersion containing the first aggregated particles and the amorphous resin particles (2); and
fusing and coalescing the second aggregated particles into toner particles by heating a dispersion containing the second aggregated particles,
wherein the toner particles contain elemental sulfur, and an elemental sulfur content in the toner particles is 0.05 mass % or more and 0.20 mass % or less relative to a mass of the toner particles.

2. The method for producing a toner for developing electrostatic charge images according to claim 1, wherein:
the amorphous resin particles (1) contain elemental sulfur, and
a value obtained by dividing the elemental sulfur content in the toner particles (a mass percentage of elemental sulfur relative to the mass of the toner particles) by an elemental sulfur content in the amorphous resin particles (1) (a mass percentage of elemental sulfur relative to a mass of an amorphous resin of the amorphous resin particles (1)) is 1 or less.

3. The method for producing a toner for developing electrostatic charge images according to claim 1, wherein:
the toner particles contain elemental nitrogen, and
a value (ppm/mass %) obtained by dividing an elemental nitrogen content (ppm) in surfaces of the toner particles by the elemental sulfur content (mass %) in the toner particles is 50 or less.

4. The method for producing a toner for developing electrostatic charge images according to claim 2, wherein:
the toner particles contain elemental nitrogen, and
a value (ppm/mass %) obtained by dividing an elemental nitrogen content (ppm) in surfaces of the toner particles by the elemental nitrogen content in the toner particles is 50 or less.
